(19) United States
(12) Patent Application Publication
(10) Pub. No.: US 2014/0031982 A1
(43) Pub. Date: Jan. 30, 2014

(54) ROBOTIC SYSTEM AND ROBOT CONTROL DEVICE

(71) Applicant: Seiko Epson Corporation, Tokyo (JP)

(72) Inventor: Yoshihito Yamada, Suwa (JP)

(21) Appl. No.: 13/938,357

(22) Filed: Jul. 10, 2013

(30) Foreign Application Priority Data
Jul. 27, 2012 (JP) 2012-166728

(51) Int. Cl. B25J 9/16

(52) U.S. Cl. CPC B25J 9/1676; Y10S 901/45; Y10S 901/27
USPC 700/255

(57) ABSTRACT

A robotic system determines whether or not a movable section including an arm having a plurality of links and a plurality of joints and an end effector disposed at a tip of the arm and an obstacle interfere with each other based on positional information of a plurality of teaching points and positional information of the obstacle when moving the movable section along the plurality of teaching points. The robotic system changes the position of predetermined one of the teaching points based on limitation information in the case in which the movable section and the obstacle interfere with each other at the predetermined one of the teaching points.

### BACKGROUND

1. Technical Field

The present invention relates to a robotic system and a robot control device.

2. Related Art

In JP-A-2008-254172 (Document 1), there is disclosed a robot program generation device of adding some via-points on a motion path connecting teaching points so that the motion path does not interfere with an obstacle and then performing a teaching correction operation in the case in which the motion path is going to interfere with the obstacle when making the robot move along the motion path.

However, according to the invention described in Document 1, there is a problem that the addition of the via-points must be performed by the operator him or herself.

### SUMMARY

An advantage of some aspects of the invention is to provide a robotic system, a robot control device, a method of controlling a robot, and a robot control program each capable of automatically correcting and adding teaching points in the case in which the robot and an obstacle are going to collide with each other.

A first aspect of the invention is directed to a robotic system including an arm having a plurality of links and a plurality of joints, an end effector disposed at a tip of the arm, an operation control section adapted to move the arm so that the end effector moves along a plurality of teaching points, a storage section adapted to store positional information of each of teaching points constituting the plurality of teaching points and limitation information in making the end effector approach the teaching point, each of which is information of each of the teaching points, an acquisition section adapted to obtain positional information of an obstacle, a first determination section adapted to determine whether or not one of the arm and the end effector and the obstacle interfere with each other at predetermined one of the plurality of teaching points when moving the end effector along the plurality of teaching points based on the positional information of the teaching point and the positional information of the obstacle, and a changing section adapted to change a position of the predetermined one of the teaching points based on the limitation information in a case in which it is determined that one of the arm and the end effector and the obstacle interfere with each other at the predetermined one of the teaching points.

According to the first aspect of the invention, in the case in which the robot and the obstacle are going to collide with each other at the teaching point, it is possible to automatically correct the teaching point to thereby prevent the robot and the obstacle from colliding with each other.

The first aspect of the invention may be configured such that the robotic system further includes a second determination section adapted to determine whether or not the end effector performs an operation at the predetermined one of the teaching points, and the changing section changes the position of the predetermined one of the teaching points in a case in which the end effector fails to perform the operation at the predetermined one of the teaching points. According to this configuration, it is possible to perform the correction of the teaching point only in the case in which the end effector does not perform an operation.

The first aspect of the invention may be configured such that the limitation information is information adapted to limit a direction in which the end effector is made to approach each of the teaching points, and the changing section changes the position of the predetermined one of the teaching points by moving the predetermined one of the teaching points by a predetermined amount in a direction indicated by the limitation information. According to this configuration, it is possible to limit the correction candidate of the teaching point to one direction to thereby reduce the processing time.

The first aspect of the invention may be configured such that the robotic system further includes a limitation information generation section adapted to generate the limitation information based on the position of the predetermined one of the teaching points, a position of another of the teaching points, through which the end effector passes before passing through the predetermined one of the teaching points, and a shape of the obstacle, and the storage section stores the limitation information generated. According to this configuration, it is possible to generate and store the limitation information regarding the teaching point thus corrected.

A modification of the first aspect of the invention is directed to a robot control device including an operation control section adapted to move an arm having a plurality of links and a plurality of joints so that an end effector disposed at a tip of the arm moves along a plurality of teaching points, an acquisition section adapted to obtain positional information of each of teaching points constituting the plurality of teaching points and limitation information in making the end effector approach the teaching point, each of which is information of each of the teaching points, and positional information of the obstacle, a first determination section adapted to determine whether or not one of the arm and the end effector and the obstacle interfere with each other at predetermined one of the plurality of teaching points when moving the end effector along the plurality of teaching points based on the positional information of the teaching point and the positional information of the obstacle, and a changing section adapted to change a position of the predetermined one of the teaching points based on the limitation information in a case in which it is determined that one of the arm and the end effector and the obstacle interfere with each other at the predetermined one of the teaching points.

Another modification of the first aspect of the invention is directed to a method of controlling a robot including: moving an arm having a plurality of links and a plurality of joints so that an end effector disposed at a tip of the arm moves along a plurality of teaching points, obtaining positional information of the plurality of teaching points and positional information of the obstacle, determining whether or not one of the arm and the end effector and the obstacle interfere with each other at predetermined one of the plurality of teaching points when moving the end effector along the plurality of teaching points based on the positional information of the plurality of teaching points and the positional information of the obstacle, and obtaining limitation information in making the end effector approach, which is limitation information to the predetermined one of the teaching points, in a case in which it is determined that one of the arm and the end effector and the obstacle interfere with each other at the predetermined one of the teaching points, and then changing the position of the predetermined one of the teaching points based on the limitation information obtained.

Still another modification of the first aspect of the invention is directed to a robot control program adapted to make an arithmetic device perform a process including moving an arm having a plurality of links and a plurality of joints so that an end effector disposed at a tip of the arm moves along a plurality of teaching points, obtaining positional information of the plurality of teaching points and positional information of an obstacle, determining whether or not one of the arm and the end effector and the obstacle interfere with each other at predetermined one of the plurality of teaching points when moving the end effector along the plurality of teaching points based on the positional information of the plurality of teaching points and the positional information of the obstacle, and obtaining limitation information in making the end effector approach, which is limitation information to the predetermined one of the teaching points, in a case in which it is determined that one of the arm and the end effector and the obstacle interfere with each other at the predetermined one of the teaching points, and then changing the position of the predetermined one of the teaching points based on the limitation information obtained.

A second aspect of the invention is directed to a robotic system including an arm having a plurality of links and a plurality of joints, an end effector disposed at a tip of the arm, an operation control section adapted to move the arm so that the end effector moves along a plurality of teaching points, a storage section adapted to store positional information of each of teaching points constituting the plurality of teaching points, approach limitation information as limitation information in making the end effector approach the teaching point, and departure limitation information as limitation information in making the end effector depart from the teaching point, each of which is information of each of the teaching points, an acquisition section adapted to obtain positional information of an obstacle, a determination section adapted to determine whether or not one of the arm and the end effector and the obstacle interfere with each other between a first one of the plurality of teaching points and a second one of the plurality of teaching points through which the end effector passes subsequently to the first one of the plurality of teaching points when moving the end effector along the plurality of teaching points based on the positional information of the plurality of teaching points and the positional information of the obstacle, and an addition section adapted to add a teaching point between the first one of the plurality of teaching points and the second one of the plurality of teaching points based on the approach limitation information and the departure limitation information in a case in which it is determined that one of the arm and the end effector and the obstacle interfere with each other between the first one of the plurality of teaching points and the second one of the plurality of teaching points.

According to the second aspect of the invention, in the case in which the robot and the obstacle are going to collide with each other between the teaching points, it is possible to automatically add a teaching point to thereby prevent the robot and the obstacle from colliding with each other between the teaching points.

The second aspect of the invention may be configured such that the addition section adds a third teaching point between the first one of the plurality of teaching points and the second one of the plurality of teaching points based on the departure limitation information with respect to the first one of the plurality of teaching points, and adds a fourth teaching point between the third teaching point and the second one of the plurality of teaching points based on the approach limitation information with respect to the second one of the plurality of teaching points. According to this configuration, it is possible to make it easy to automatically perform the addition of the teaching point.

The second aspect of the invention may be configured such that the approach limitation information is information adapted to limit a direction in which the end effector is made to approach each of the teaching points, the departure limitation information is information adapted to limit a direction in which the end effector is made to depart from each of the teaching points, and the addition section determines a position obtained by shifting the first one of the plurality of teaching points by a predetermined amount in a direction indicated by the departure limitation information as a position of the third teaching point, and adds the fourth teaching point at a position obtained by shifting the second one of the plurality of teaching points by a predetermined amount in a direction indicated by the approach limitation information. According to this configuration, it is possible to limit the addition candidate of the teaching point to one direction to thereby reduce the processing time.

The second aspect of the invention may be configured such that the robotic system further includes a limitation information generation section adapted to generate the approach limitation information and the departure limitation information based on the positions of the first one of the plurality of teaching points and the second one of the plurality of teaching points and a shape of the obstacle, and the storage section stores the approach limitation information generated and the departure limitation information generated. According to this configuration, it is possible to generate and store the approach limitation information and the departure limitation information of the teaching point thus added.

A modification of the second aspect of the invention is directed to a robot control device including an operation control section adapted to move an arm having a plurality of links and a plurality of joints so that an end effector disposed at a tip of the arm moves along a plurality of teaching points, an acquisition section adapted to obtain positional information of each of teaching points constituting the plurality of teaching points, approach limitation information as limitation information in making the end effector approach the teaching point, and departure limitation information as limitation information in making the end effector depart from the teaching point, each of which is information of each of the teaching points, and positional information of an obstacle, a determination section adapted to determine whether or not one of the arm and the end effector and the obstacle interfere with each other between a first one of the plurality of teaching points and a second one of the plurality of teaching points through which the end effector passes subsequently to the first one of the plurality of teaching points when moving the end effector along the plurality of teaching points based on the positional information of the plurality of teaching points and the positional information of the obstacle, and an addition section adapted to add a teaching point between the first one of the plurality of teaching points and the second one of the plurality of teaching points based on the approach limitation information and the departure limitation information in a case in which it is determined that one of the arm and the end effector and the obstacle interfere with each other between the first one of the plurality of teaching points and the second one of the plurality of teaching points.

Another modification of the second aspect of the invention is directed to a method of controlling a robot including: moving an arm having a plurality of links and a plurality of joints so that an end effector disposed at a tip of the arm moves along a plurality of teaching points, obtaining positional information of the plurality of teaching points and positional information of an obstacle, determining whether or not one of the arm and the end effector and the obstacle interfere with each other between a first one of the plurality of teaching points and a second one of the plurality of teaching points through which the end effector passes subsequently to the first one of the plurality of teaching points when moving the end effector along the plurality of teaching points based on the positional information of the plurality of teaching points and the positional information of the obstacle, obtaining approach limitation information with respect to the second one of the plurality of teaching points, which is approach limitation information as limitation information in making the end effector approach the teaching point in a case in which it is determined that one of the arm and the end effector and the obstacle interfere with each other between the first one of the plurality of teaching points and the second one of the plurality of teaching points, and obtaining departure limitation information with respect to the first one of the plurality of teaching points, which is departure limitation information as limitation information in making the end effector depart from the teaching point, adding a third teaching point between the first one of the plurality of teaching points and the second one of the plurality of teaching points based on the departure limitation information with respect to the first one of the plurality of teaching points, and adding a fourth teaching point between the third teaching point and the second one of the plurality of teaching points based on the approach limitation information with respect to the second one of the plurality of teaching points.

Still another modification of the second aspect of the invention is directed to a robot control program adapted to make an arithmetic device perform a process including: moving an arm having a plurality of links and a plurality of joints so that an end effector disposed at a tip of the arm moves along a plurality of teaching points, obtaining positional information of the plurality of teaching points and positional information of an obstacle, determining whether or not one of the arm and the end effector and the obstacle interfere with each other between a first one of the plurality of teaching points and a second one of the plurality of teaching points through which the end effector passes subsequently to the first one of the plurality of teaching points when moving the end effector along the plurality of teaching points based on the positional information of the plurality of teaching points and the positional information of the obstacle, obtaining approach limitation information with respect to the second one of the plurality of teaching points, which is approach limitation information as limitation information in making the end effector approach the teaching point in a case in which it is determined that one of the arm and the end effector and the obstacle interfere with each other between the first one of the plurality of teaching points and the second one of the plurality of teaching points, and obtaining departure limitation information with respect to the first one of the plurality of teaching points, which is departure limitation information as limitation information in making the end effector depart from the teaching point, adding a third teaching point between the first one of the plurality of teaching points and the second one of the plurality of teaching points based on the departure limitation information with respect to the first one of the plurality of teaching points, and adding a fourth teaching point between the third teaching point and the second one of the plurality of teaching points based on the approach limitation information with respect to the second one of the plurality of teaching points.

### BRIEF DESCRIPTION OF THE DRAWINGS

The invention will be described with reference to the accompanying drawings, wherein like numbers reference like elements.

FIG. 1 is a system configuration diagram showing an example of a configuration of a robotic system according to an embodiment of the invention.

FIG. 2 is a block diagram showing an example of a functional configuration of the robotic system.

FIG. 3 is a diagram showing an example of teaching point information.

FIG. 4 is a diagram showing an example of interference information.

FIG. 5 is a diagram showing an example of obstacle information.

FIG. 6 is a diagram showing a hardware configuration of a control section.

FIG. 7 is a flowchart showing the flow of a teaching point correction process of the robotic system.

FIG. 8 is a diagram for explaining the teaching point correction process.

FIG. 9 is a flowchart showing the flow of a approach limitation information generation process of the robotic system.

FIG. 10 is a diagram for explaining the approach limitation information generation process.

FIG. 11 is a flowchart showing the flow of a process of the teaching point correction step of the teaching point correction process.

FIG. 12 is a diagram for explaining the teaching point correction step.

FIG. 13 is a flowchart showing the flow of a teaching point addition process of the robotic system.

FIG. 14 is a diagram for explaining the teaching point addition process.

FIG. 15 is a flowchart showing the flow of a departure limitation information generation process of the robotic system.

FIG. 16 is a diagram for explaining the teaching point addition process.

### DESCRIPTION OF AN EXEMPLARY EMBODIMENT

An embodiment of the invention will be explained with reference to the accompanying drawings.

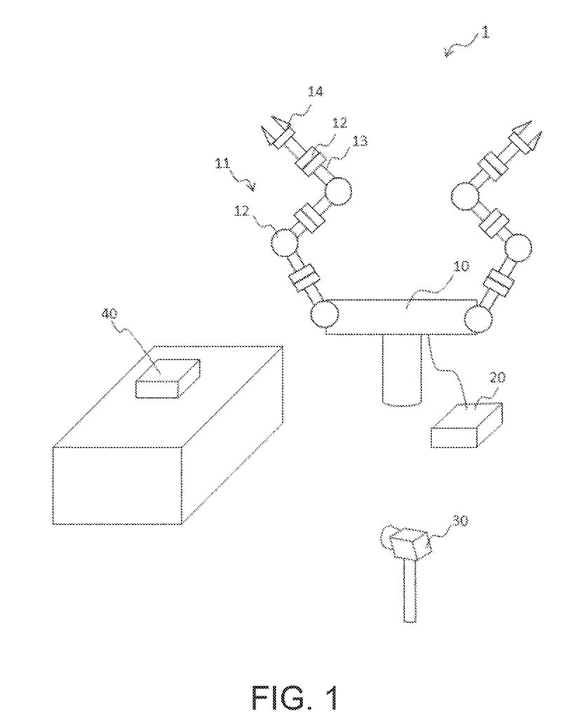

FIG. 1 is a system configuration diagram showing an example of a configuration of a robotic system 1 according to the embodiment of the invention. The robotic system 1 according to the present embodiment is mainly provided with a robot 10, a control section 20, and a shooting section 30.

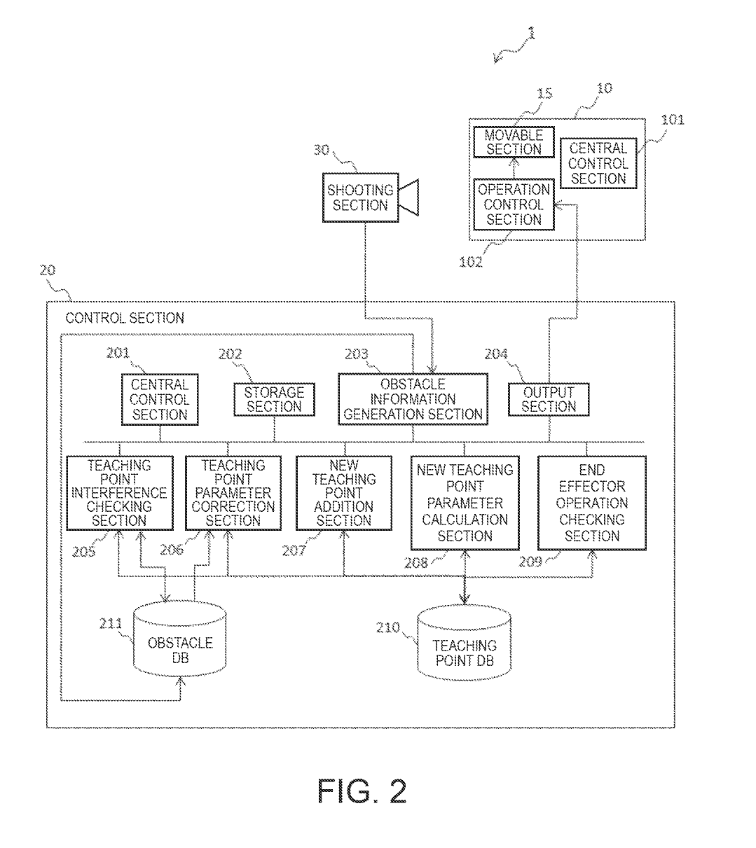

The robot 10 is an arm type robot provided with arm sections 11 and hands 14 disposed on the tips of the respective arm sections 11. It should be noted that although a so-called dual-arm robot having two arm sections 11 is shown in FIG. 1, the robot can also be provided with a single robot arm. Hereinafter, the arm section 11 and the hand 14 are referred to as a movable section 15 (see, e.g., FIG. 2).

The arm section 11 includes a plurality of joints (articulations) 12, and a plurality of links 13.

Each of the joints 12 rotatably connects the links 13 to each other, a pedestal (a body) of the robot 10 and the link 13 to each other, and so on. Each of the joints 12 is, for example, a rotary joint, and is disposed so as to be able to vary the angle between the links 13 and to cause a shaft rotation of the link 13. Therefore, by driving the joints 12 in cooperation with each other, it is possible to freely move the hand 14 within a predetermined movable range, and at the same time point the hand 14 in an arbitrary direction.

The hand 14 is provided with, for example, two or more fingers, and by bending and moving the fingers, the hand 14 grips a work 40 by pinching. It is obvious that the configuration of the hand 14 is not particularly limited providing the hand 14 can grip the work 40. It should be noted that in the present embodiment, the position of the hand 14 is called a “working point” of the movable section 15 (a so-called end effector).

The hand 14 is provided with a sensor (not shown). The sensor detects, for example, an external force applied to the hand 14.

Further, the joints 12 and the hands 14 are each provided with an actuator (not shown) for operating the joint 12 or the hand 14. The actuator is provided with, for example, a servomotor and an encoder. An encoder value output by the encoder is used for feedback control of the robot 10 performed by the control section 20.

It should be noted that the configuration of the robot 10 is explained above with respect to the principal constituents only for explaining the features of the present embodiment, but is not limited thereto. A configuration provided to a typical gripping robot is not excluded. For example, although FIG. 1 shows six-axis arms, the number of axes (the number of joints) can be increased or decreased. The number of links can also be increased or decreased. Further, the shape, the size, the arrangement, the structure, and so on of each of the various members such as the arm, the hand, the link, and the joint can arbitrarily be changed.

The shooting section 30 is a unit for shooting the external environment (e.g., the vicinity of a workbench shown in the drawing) of the robot 10 to thereby generate image data. The shooting section 30 includes, for example, a camera, and is installed on the workbench, the ceiling, an wall, and so on.

The shooting section 30 shoots an attention point X of the hand 14 and the work 40 from a predetermined direction, for example, a diagonally forward right direction in FIG. 1. It should be noted that the shooting direction of the shooting section 30 is not limited thereto.

The control section 20 performs a process of controlling the whole of the robot 10. The control section 20 can be installed in a place distant from the main body of the robot 10 (so as to be operated remotely), or can be incorporated in the robot 10.

Then, an example of a functional configuration of the robotic system 1 will be explained. FIG. 2 is a functional block diagram of the robotic system 1.

The robot 10 is mainly provided with a central control section 101 and an operation control section 102.

The central control section 101 integrally controls other sections (102) than itself and so on.

The operation control section 102 controls the movable section 15 based on information output from an output section 204, the encoder values of the actuators, the sensor value of the sensor, and so on. For example, the operation control section 102 drives the actuators so as to move the movable section 15 along the information of the teaching point output from the output section 204. Further, in the case in which it is instructed in the information of the teaching point to operate the end effector, the operation control section 102 operates the hand 14 to grip the work 40.

The control section 20 is provided with a central control section 201, a storage section 202, an obstacle information generation section 203, the output section 204, a teaching point interference checking section 205, a teaching point parameter correction section 206, a new teaching point addition section 207, a new teaching point parameter calculation section 208, an end effector operation checking section 209, a teaching point DB 210, and an obstacle DB 211.

The central control section 201 integrally controls other sections (202 through 211) than itself.

The storage section 202 stores various data and programs.

The obstacle information generation section 203 obtains the image data shot by the shooting section 30, then generates the obstacle information based on the image data, and then stores the obstacle information in the obstacle DB 211. The obstacle information will be explained later in detail.

The output section 204 outputs the information representing, for example, the amount and the direction of the movement of the movable section 15 to the operation control section 102. For example, in the case in which the teaching point and the work 40 do not interfere with each other in the teaching point interference checking section 205, the output section 204 obtains the information of the teaching point from the teaching point DB 210, and then outputs the information to the operation control section 102.

The teaching point interference checking section 205 checks whether or not the movable section 15 and the work (the obstacle) interfere with each other based on the information of the teaching point stored in the teaching point DB 210 and the information of the obstacle stored in the obstacle DB 211. Further, the teaching point interference checking section 205 checks whether or not the movable section 15 and the work 40 (the obstacle) interfere with each other on a motion pathway (path) connecting the teaching point and another teaching point based on the information of the teaching points stored in the teaching point DB 210 and the information of the obstacle stored in the obstacle DB 211.

The teaching point parameter correction section 206 calculates a parameter (described later in detail) of the teaching point, which has been determined by the teaching point interference checking section 205 to have the movable section 15 and the obstacle interfering with each other. Further, the teaching point parameter correction section 206 corrects the teaching point in the teaching point DB 210 using the parameter thus calculated.

The new teaching point addition section 207 adds a new teaching point when it is confirmed by the teaching point interference checking section 205 that the movable section 15 and the obstacle interfere with each other on the path.

The new teaching point parameter calculation section 208 calculates the parameter of the teaching point thus added by the new teaching point addition section 207. Further, the new teaching point parameter calculation section 208 adds the teaching point the parameter of which is thus calculated to the teaching point DB 210.

The end effector operation checking section 209 checks whether or not the end effector operation is set at the teaching point interfering with the work 40 (the obstacle) based on the information of the teaching point stored in the teaching point DB 210 and the information of the obstacle stored in the obstacle DB 211.

It should be noted that the details of the process performed by the teaching point interference checking section 205, the teaching point parameter correction section 206, the new teaching point addition section 207, the new teaching point parameter calculation section 208, and the end effector operation checking section 209 will be described later in detail.

The teaching point DB 210 stores teaching point information 2101 and interference information 2102. The obstacle DB 211 stores obstacle information 2111.

The teaching point information 2101 is the information of a group of the teaching points of the robot. The information of the teaching points having previously been set is previously stored in the teaching point information 2101. The information of the teaching point thus modified or added is added to the teaching point information 2101 by the teaching point parameter correction section 206 or the new teaching point parameter calculation section 208.

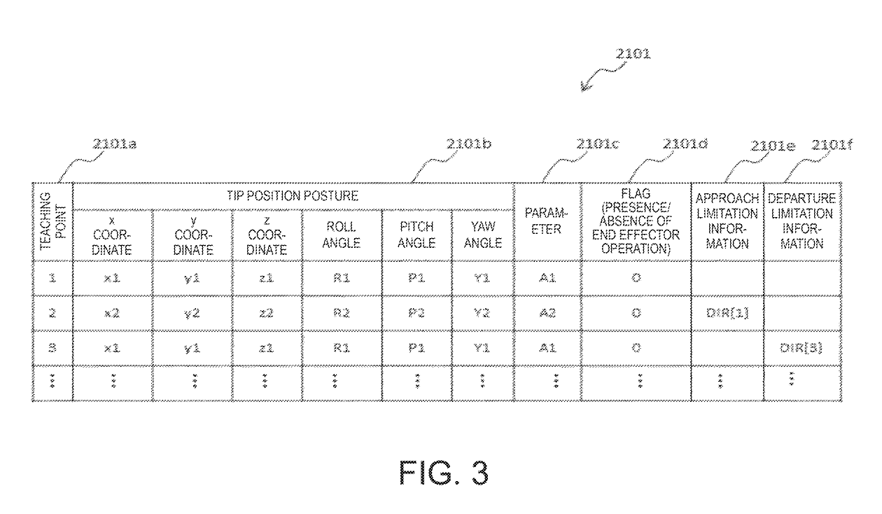

FIG. 3 is a diagram showing the teaching point information 2101. The teaching point information 2101 is mainly provided with a teaching point number storage area 2101a, a tip position posture storage area 2101b, a parameter storage area 2101c, a flag storage area 2101d, an approach limitation information storage area 2101e, and a departure limitation information storage area 2101f. The teaching point number storage area 2101a, the tip position posture storage area 2101b, the parameter storage area 2101c, the flag storage area 2101d, the approach limitation information storage area 2101e, and the departure limitation information storage area 2101f are associated with each other.

The teaching point number storage area 2101a stores identification information (e.g., the number) of the teaching point. The operation control section 102 moves the movable section 15 along the path connecting the teaching points in the ascending order of the numbers.

The tip position posture storage area 2101b stores the target position and the posture of the tip of the robot. The target position of the tip of the robot is determined by the x coordinate, the y coordinate, and the z coordinate of the tip of the hand 14. The posture of the tip of the robot is determined by the roll angle, the pitch angle, and the yaw angle of the hand 14, and the parameter. It should be noted that the x coordinate, the y coordinate, and the z coordinate are the coordinates in the coordinate system (the robot coordinate system) of the robot 10 recognized by the control section 20.

The parameter storage area 2101c stores the parameter for uniquely determining the redundant degree of freedom. For example, in the case of the three-dimensional 7-axis robot, it is possible to adopt the parameter for determining the position of the part corresponding to the elbow of the arm section 11.

The flag storage area 2101d stores a flag representing whether or not the end effector operation process is performed in the target position posture of the tip of the robot. In the case in which “0” is stored in the flag storage area 2101d, it shows that the end effector operation will not be performed. In the case in which “1” is stored in the flag storage area 2101d, it shows that the end effector operation will be performed.

The approach limitation information storage area 2101e stores the presence or absence of the limitation regarding the position and the posture of the movable section 15 and the content of the limitation when making the movable section 15 approach the teaching point stored in the tip position posture storage area 2101b. In the case in which no information is stored in the approach limitation information storage area 2101e, it shows that there is no limitation in making the movable section 15 approach the teaching point. In the present embodiment, the information (e.g., DIR[1]) stored in the approach limitation information storage area 2101e is a directional vector for indicating the direction of the limitation, and represents that the movable section 15 can be made to approach only from the direction indicated by DIR[1]. The details of the information stored in the approach limitation information storage area 2101e will be described later in detail.

The departure limitation information storage area 2101f stores the presence or absence of the limitation regarding the position and the posture of the movable section 15 and the content of the limitation when making the movable section 15 depart (distancing the movable section 15) from the target position of the tip of the robot stored in the tip position posture storage area 2101b (when moving the movable section 15 to the next teaching point). In the case in which no information is stored in the departure limitation information storage area 2101f, it shows that there is no limitation in making the movable section 15 depart from the teaching point. In the present embodiment, the information (e.g., DIR[3]) stored in the departure limitation information storage area 2101f is a directional vector for indicating the direction of the limitation, and represents that the movable section 15 can be made to depart therefrom only in the direction indicated by DIR[3]. The details of the information stored in the departure limitation information storage area 2101f will be described later in detail.

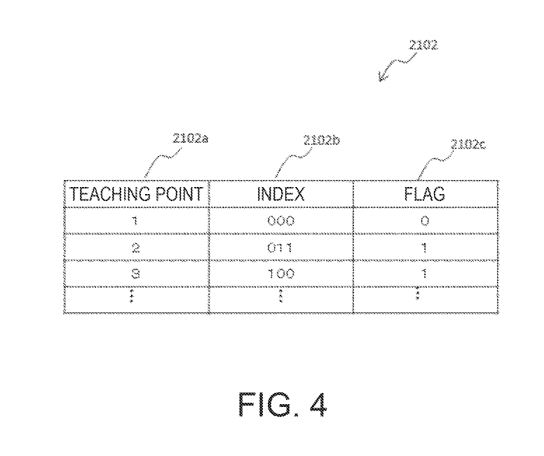

The interference information 2102 is the information of a group of the teaching points of the robot thus set. FIG. 4 is a diagram exemplifying the interference information 2102. The interference information 2102 is mainly provided with a teaching point number storage area 2102a, an index storage area 2102b, and a robot operation possible/impossible flag storage area 2102c. The teaching point number storage area 2102a is the same as the teaching point number storage area 2101a, and therefore, the explanation thereof will be omitted.

The index storage area 2102b stores indexes each representing that the interference between the robot 10 and the obstacle occurs in the case in which the movable section 15 is located at the teaching point with respect to each of the teaching points the numbers of which are stored in the teaching point number storage area 2102a. Further, the index storage area 2102b stores indexes each representing that the interference between the robot 10 and the obstacle occurs in the case of moving the movable section 15 along the path connecting the teaching points.

In the present embodiment, in the case in which “0” is stored in the first digit of the index storage area 2102b, it shows that no interference between the robot 10 and the obstacle occurs in the corresponding teaching point when placing the movable section 15 at the teaching point, and in the casein which “1” is stored, it shows that the interference between the robot 10 and the obstacle occurs when placing the movable section 15 at the teaching point. Further, in the case in which “0” is stored in the second digit of the index storage area 2102b, it shows that no interference between the robot 10 and the obstacle occurs during the period of moving the robot 10 from the corresponding teaching point to the next teaching point, and in the case in which “1” is stored, it shows that the interference between the robot 10 and the obstacle occurs during the period of moving the movable section 10 from the teaching point to the next teaching point. Further, in the case in which “0” is stored in the third digit of the index storage area 2102b, it shows that no interference between the robot 10 and the obstacle occurs during the period of moving the robot 10 from the previous teaching point to the corresponding teaching point, and in the case in which “1” is stored, it shows that the interference between the robot 10 and the obstacle occurs during the period of moving the robot 10 from the previous teaching point to the teaching point.

Since in the example shown in FIG. 4, “011” is stored in the index storage area 2102b in the case in which the number 2 is stored in the teaching point number storage area 2102a, it is recognized that the interference between the robot 10 and the obstacle occurs when placing the movable section 15 at the teaching point with the number 2, and the interference between the robot 10 and the obstacle occurs in the period of moving the robot 10 from the teaching point with the number 2 to the teaching point with the number 3. In the case in which the number 3 is stored in the teaching point number storage area 2102a, since “100” is stored in the index storage area 2102b, it is recognized that the interference between the robot 10 and the obstacle occurs during the period in which the robot 10 moves from the teaching point 2, the previous teaching point of the teaching point with the number 3.

The robot operation possible/impossible flag storage area 2102c stores the flag representing whether or not the teaching point can be realized. In the case in which “0” is stored in the robot operation possible/impossible flag storage area 2102c, it shows that the corresponding teaching point can be realized. In the case in which “1” is stored in the robot operation possible/impossible flag storage area 2102c, it shows that the corresponding teaching point cannot be realized.

In the example shown in FIG. 4, in the case in which the number 2 is stored in the teaching point number storage area 2102a, “1” is stored in the robot operation possible/impossible flag storage area 2102c, which shows the fact that the teaching point with the number 2 cannot be realized.

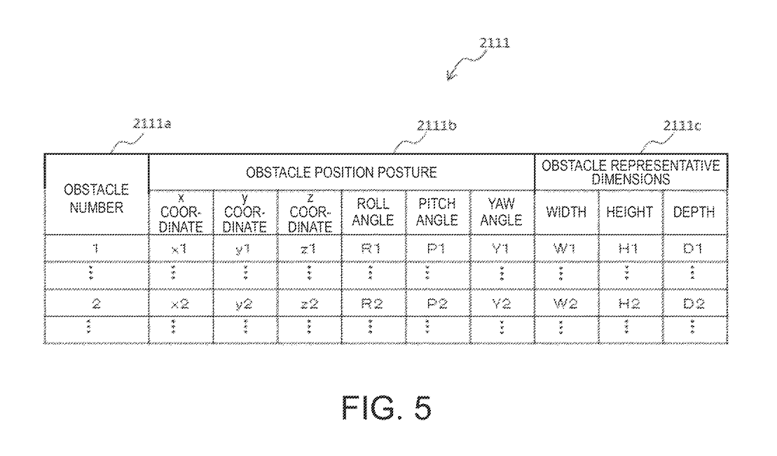

The obstacle information 2111 is the information representing the dimensions, the position, and the posture of the work, peripheral equipment, and so on other than the robot 10 existing in the working space. FIG. 5 is a diagram showing the obstacle information 2111. The obstacle information 2111 is mainly provided with an obstacle number storage area 2111a, an obstacle coordinate storage area 2111b, and an obstacle dimension storage area 2111c.

The obstacle number storage area 2111a stores the numbers of the obstacles. The numbers of the obstacles are provided in the order in which the obstacle information generation section 203 recognizes the obstacles for the sake of convenience.

The obstacle coordinate storage area 2111b stores the x coordinate, the y coordinate, and the z coordinate representing the position of the obstacle in the robot coordinate system, and the roll angle, the pitch angle, and the yaw angle representing the posture of the obstacle. In the present embodiment, since the rectangular solid surrounding the obstacle is assumed, the representative dimensions of the width, the height, and the depth are stored for each of the obstacles. It should be noted that in the case in which the obstacle has a spherical shape, it is possible to store a set of the x coordinate, the y coordinate, and the z coordinate representing the center in the obstacle coordinate storage area 2111b, and the value of the radius in the obstacle dimension storage area 2111c. The x coordinate, the y coordinate, and the z coordinate in the obstacle coordinate storage area 2111b are the same as the coordinate system stored in the tip position posture storage area 2101b, namely the coordinates of the robot 10 recognized by the control section 20.

It should be noted that the functional configurations of the robot 10 and the control section 20 are categorized in accordance with the major processing contents in order to make the configuration of the robot 10 and the control section 20 easy to understand. The invention is never limited by the way of categorizing the constituents or the names of the constituents. The configuration of the robot 10 and the control section 20 can further be categorized into a larger number of constituents. Further, it is also possible to perform the categorization so that each of the constituents performs a larger number of processes. Further, the processing of each of the constituents can be performed by a single hardware system, or can be performed by a plurality of hardware systems.

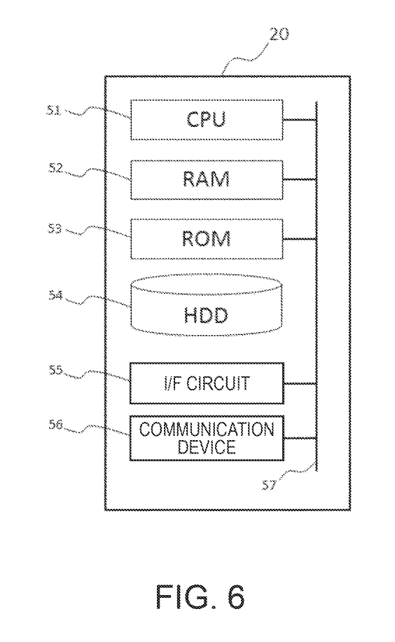

FIG. 6 is a block diagram showing an example of a schematic configuration of the control section 20. As shown in the drawing, the control section 20 is provided with a CPU 51 as an arithmetic device, a RAM 52 as a volatile storage device, a ROM 53 as a nonvolatile storage device, a hard disk drive (HDD) 54, an interface (I/F) circuit 55 for connecting the control section 20 and other units to each other, a communication device 56 for performing communication with an external device of the robot 10, and a bus 57 for connecting these devices to each other.

Each of the functional sections other than the storage section 202 described above is realized by, for example, the CPU 51 reading out to the RAM 52 and then executing a predetermined program stored in the ROM 53. The storage section 202 is realized by, for example, the RAM 52, the ROM 53, or the HDD 54. It should be noted that the predetermined program described above can previously be installed in the ROM 53, for example, or can be downloaded from a network via the communication device 56, and then installed or updated.

The configuration of the robotic system 1 described above is explained above with respect to the principal constituents only for explaining the features of the present embodiment, but is not limited thereto. The robot 10 can be provided with the control section 20, or can be provided with the shooting section 30. Further, a configuration provided to a typical robot is not excluded.

Then, the characteristic process of the robotic system 1 having the above configuration according to the present embodiment will be explained. In the present embodiment, as the characteristic processes of the robotic system 1, there can be cited two processes, namely a teaching point correction process and a teaching point addition process. Hereinafter, the two processes will be explained in series. It should be noted that the explanation will be presented assuming that the robot 10 can move two-dimensionally (does not move three-dimensionally) for the sake of convenience of explanation. Further, the explanation will be presented assuming that there is no interference of the robot 10 itself, and only the interference between the robot 10 and the obstacle will occur.

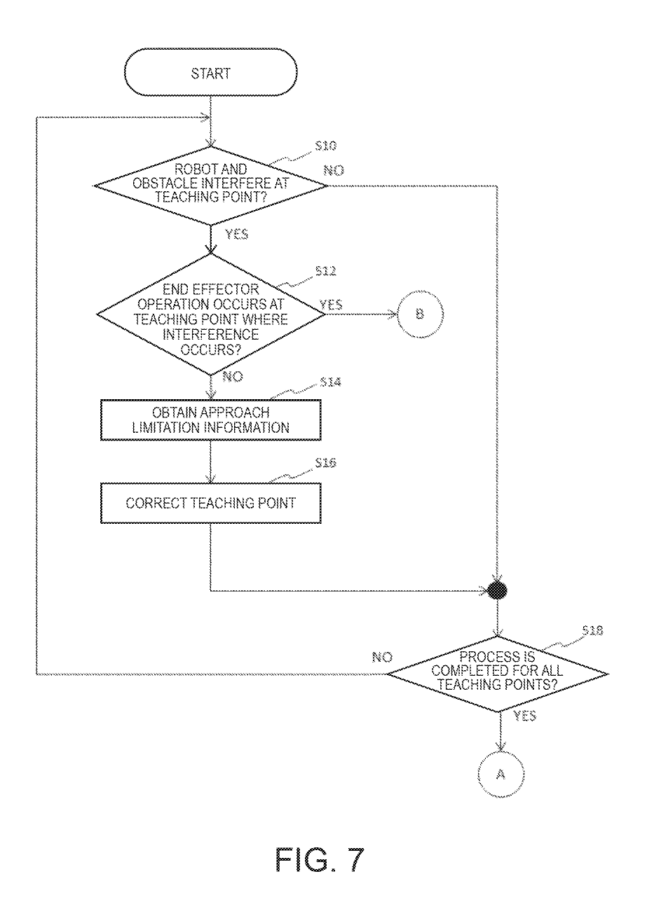

FIG. 7 is a flowchart showing the flow of the teaching point correction process of the robotic system 1. The process is started in response to, for example, an interference checking instruction input via a button or the like not shown.

### Step S10

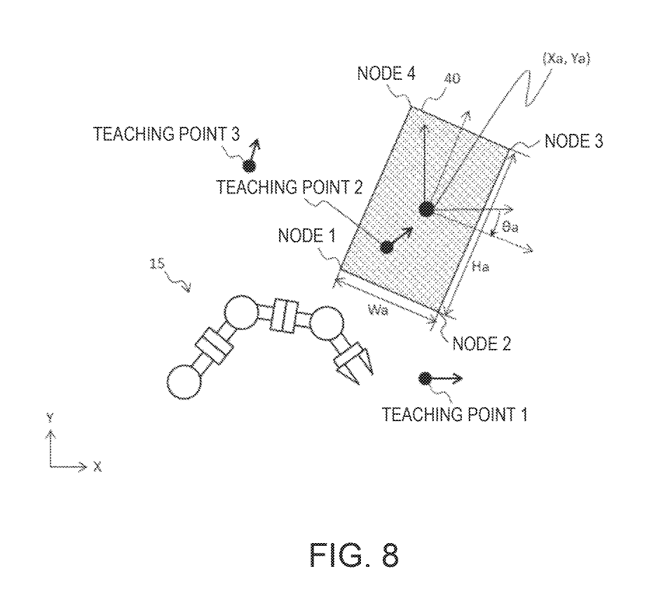

The teaching point interference checking section 205 obtains the positional information of each of the teaching points from the teaching point information 2101. Further, the teaching point interference checking section 205 obtains the obstacle information 2111 from the obstacle DB 211. Then, the teaching point interference checking section 205 determines whether or not the teaching point interferes with the obstacles stored in the obstacle DB 211 with respect to each of the teaching points stored in the teaching point information 2101. The present process will be explained specifically using FIG. 8.

The teaching point interference checking section 205 recognizes the area where the obstacle exists based on the obstacle information 2111. Since the rectangular obstacle (the work 40 in this case) represented by the position (Xa, Ya), the posture (θa), and the representative dimensions La, Wa is obtained from the obstacle coordinate storage area 2111b, the teaching point interference checking section 205 recognizes the rectangular area (hatched section in FIG. 8) as the area where the obstacle exists.

The teaching point interference checking section 205 determines whether or not the positional information (the x coordinate, the y coordinate, and the z coordinate) of the teaching point obtained from the tip position posture storage area 2101b is included in the area where the obstacle exists. Since the teaching point 2 is included in the area where the obstacle exists, the teaching point interference checking section 205 determines that the teaching point 2 interferes with the obstacle.

It should be noted that in FIG. 8, the arrows displayed at the respective teaching points are arrows for indicating the tip posture direction. The tip posture direction denotes a direction in which the tip of the hand 14 is pointed, and can be obtained using the roll angle, the pitch angle, and the yaw angle of the hand 14 stored in the tip position posture storage area 2101b, and the parameter stored in the parameter storage area 2101c.

Further, the teaching point interference checking section 205 generates the interference information 2102 based on the determination result. Specifically, the teaching point interference checking section 205 stores the number of the teaching point in the teaching point number storage area 2102a. Further, the teaching point interference checking section 205 stores “0” in the first digit of the index storage area 2102b in the case in which the teaching point is not included in the area where the obstacle exists, or stores “1” in the first digit of the index storage area 2102b in the case in which the teaching point is included in the area where the obstacle exists. Further, the teaching point interference checking section 205 stores “0” in the robot operation possible/impossible flag storage area 2102c in the case in which “0” has been stored in all of the digits of the index storage area 2102b, or stores “1” in the robot operation possible/impossible flag storage area 2102c in the case in which “1” has been stored in any of the digits of the index storage area 2102b. Thus, it is possible to know the presence or absence of the interference by obtaining the interference information 2102 on and after the subsequent process.

Going back to the explanation of FIG. 7, in the case (NO in the step S10) in which it is determined that the teaching point fails to interfere with the obstacle, the process proceeds to the step S18. In the case (YES in the step S10) in which it is determined that the teaching point interferes with the obstacle, the process proceeds to the step S12.

### Step S12

The teaching point interference checking section 205 outputs the information of the teaching point at which the interference occurs to the end effector operation checking section 209. The end effector operation checking section 209 obtains the teaching point information 2101 from the teaching point DB 210, and then determines whether or not there is the setting of performing the operation of the end effector at the teaching point input from the teaching point interference checking section 205 based on the teaching point information 2101.

In the example shown in FIG. 8, since it is determined that the teaching point 2 is included in the area where the obstacle exists, the end effector operation checking section 209 obtains the information stored in the flag storage area 2101d of the teaching point information 2101, the information being associated with the information with the number of “2” stored in the teaching point number storage area 2101a. In the teaching point information 2101 shown in FIG. 3, the information in the flag storage area 2101d in the casein which the teaching point number storage area 2101a is “2” is “0.” Therefore, the end effector operation checking section 209 determines that the end effector operation is not performed at the teaching point 2.

In the case (YES in the step S12) in which there is the setting of performing the end effector operation at the teaching point at which the interference occurs, the end effector operation checking section 209 outputs the information representing this situation to the central control section 201, and then the central control section 201 performs a process B. In the case (NO in the step S12) in which there is the setting of not performing the end effector operation at the teaching point at which the interference occurs, the process proceeds to the step S14.

### Process B

The process B is an error process. The error process is a process of making the operator recognize that the operation is impossible, and at the same time stopping all of the processes of the robotic system 1 including the teaching point correction process. As the process of making the operator recognize the situation, it is possible to adopt, for example, a process of displaying the fact that a re-examination of the line is necessary on a display section not shown.

### Step S14

The end effector operation checking section 209 outputs the number of the teaching point at which the interference with the obstacle occurs, and the fact that the end effector operation is not performed at the teaching point to the teaching point parameter correction section 206. The teaching point parameter correction section 206 obtains the information, which is associated with the number of the teaching point obtained from the end effector operation checking section 209, and is stored in the approach limitation information storage area 2101e of the teaching point information 2101, from the teaching point DB 210.

In the case in which no information is stored in the approach limitation information storage area 2101e, the teaching point parameter correction section 206 generates the approach limitation information and then stores the approach limitation information in the approach limitation information storage area 2101e.

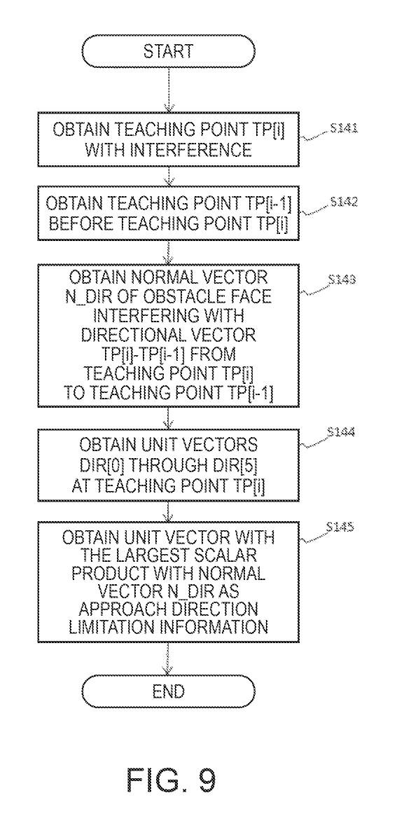

The method of generating the approach limitation information performed by the teaching point parameter correction section 206 will be explained. FIG. 9 is a flowchart showing the flow of a process of generating the approach limitation information performed by the teaching point parameter correction section 206.

The teaching point parameter correction section 206 obtains (step S141) the x coordinate, the y coordinate, and the z coordinate associated with the teaching point TP[i], which are the information related to the position of the teaching point TP[i] at which the interference with the obstacle occurs, namely the information stored in the tip position posture storage area 2101b, from the teaching point DB 210. In the case in which the number of the teaching point is 2, −TP[i]=2, namely i=2 is denoted. In the case in which the teaching point at which the interference with the obstacle occurs is the teaching point 2, the teaching point parameter correction section 206 obtains the x coordinate “x2,” the y coordinate “y2,” and the z coordinate “z2” from the teaching point information 2101 (see FIG. 3).

The teaching point parameter correction section 206 obtains (step S142) the x coordinate, the y coordinate, and the z coordinate associated with the teaching point TP[i−1], which are the information related to the position of the teaching point TP[i−1] previous to the teaching point at which the interference with the obstacle occurs, namely the information stored in the tip position posture storage area 2101b, from the teaching point DB 210. In the case in which i=2 is set in the step S141, −TP[i−1]=1, namely the information related to the position of the teaching point 1 is obtained from the teaching point information 2101.

The teaching point parameter correction section 206 obtains the directional vector TP[i]−TP[i−1] from the teaching point TP[i] to the teaching point TP[i−1] based on the positional information of the teaching points obtained in the steps S141, S142. Further, the teaching point parameter correction section 206 obtains the obstacle information 2111 from the obstacle DB 211, and then obtains (step S143) the normal vector N_DIR on the face of the obstacle interfering with the directional vector TP[i]−TP[i−1].

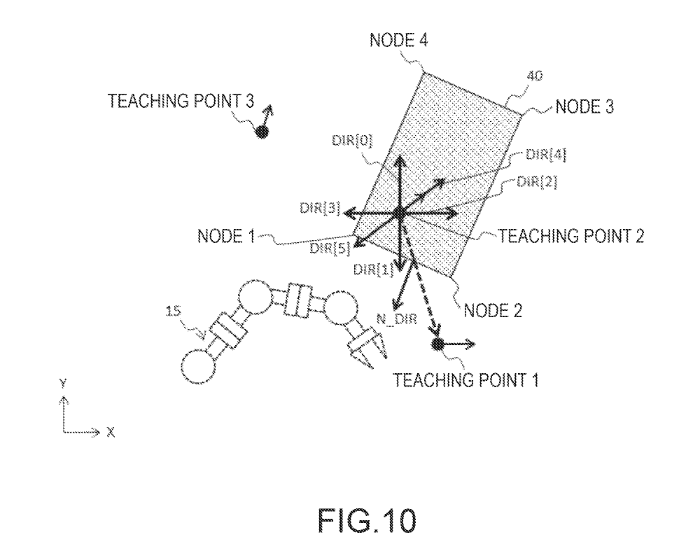

The process of the step S143 will be explained using FIG. 10. Since i=2 is set, the directional vector TP[i]−TP[i−1] is represented by the dotted arrow directed from the teaching point 2 toward the teaching point 1 in FIG. 10.

The teaching point parameter correction section 206 obtains the rectangle represented by the position (Xa, Ya), the posture θa, and the representative dimensions La, Wa of the obstacle (the work 40 in this case) from the obstacle coordinate storage area 2111b. The face of the work 40 intersecting with the directional vector TP[i]−TP[i−1] corresponds to the line connecting the node 1 and the node 2. In FIG. 10, the teaching point parameter correction section 206 obtains the arrow perpendicular to the line connecting the node 1 and the node 2 and directed toward the outside of the work 40 as the normal vector N_DIR.

It should be noted that in the case in which the face of the work 40 is not a plane (e.g., the case in which the work is not a rectangular solid), it can be defined as the normal vector at the position where the work 40 intersects with the directional vector TP[i]−TP[i−1].

Going back to the explanation of FIG. 9, the teaching point parameter correction section 206 obtains (step S144) directional unit vectors DIR[0] through DIR[5] in the teaching point TP[i]. The directional unit vectors DIR[0] through DIR[5] will be explained using FIG. 10.

DIR[0] is a unit vector with a direction of limiting the x coordinate to a fixed value (i.e., having the x coordinate equal to the x coordinate of the teaching point TP[i]) and increasing the y coordinate in the +Δy direction.

DIR[1] is a unit vector with a direction of limiting the x coordinate to a fixed value and increasing the y coordinate in the −Δy direction.

DIR[2] is a unit vector with a direction of limiting the y coordinate to a fixed value (i.e., having the y coordinate equal to the y coordinate of the teaching point TP[i]) and increasing the x coordinate in the +Δx direction.

DIR[3] is a unit vector with a direction of limiting the y coordinate to a fixed value and increasing the x coordinate in the −Δx direction.

DIR[4] is a unit vector with the same direction as the tip posture direction.

DIR[5] is a unit vector with the opposite direction to the tip posture direction.

It should be noted that the directional unit vectors are not limited to DIR[0] through DIR[5] shown in FIG. 10. The number of the directional unit vectors is not limited to six, but can be smaller than six, or larger than six. Further, the directions of the directional unit vectors are not limited thereto.

Going back to the explanation of FIG. 9, the teaching point parameter correction section 206 obtains (step S145) the directional unit vector having the greatest scalar product with the normal vector N_DIR out of the directional unit vectors DIR[0] through DIR[5] as approach direction limitation information. The greatest scalar product denotes the fact that the directional unit vector is the most similar to the normal vector N_DIR. In the case shown in FIG. 10, the directional unit vector DIR[1] is the most similar to the normal vector N_DIR, and is therefore obtained as the approach direction limitation information. The approach direction limitation information obtained in the step S145 is the direction of departing from the surface of the obstacle.

Thus, the approach direction limitation information is calculated. The teaching point parameter correction section 206 stores the approach direction limitation information thus calculated in the approach limitation information storage area 2101e of the teaching point information 2101, and then terminates the approach direction limitation information calculation process. It should be noted that the process shown in FIG. 9 is an example of the process of generating the approach limitation information, and the content of the approach limitation information is not particularly limited thereto.

### Step S16

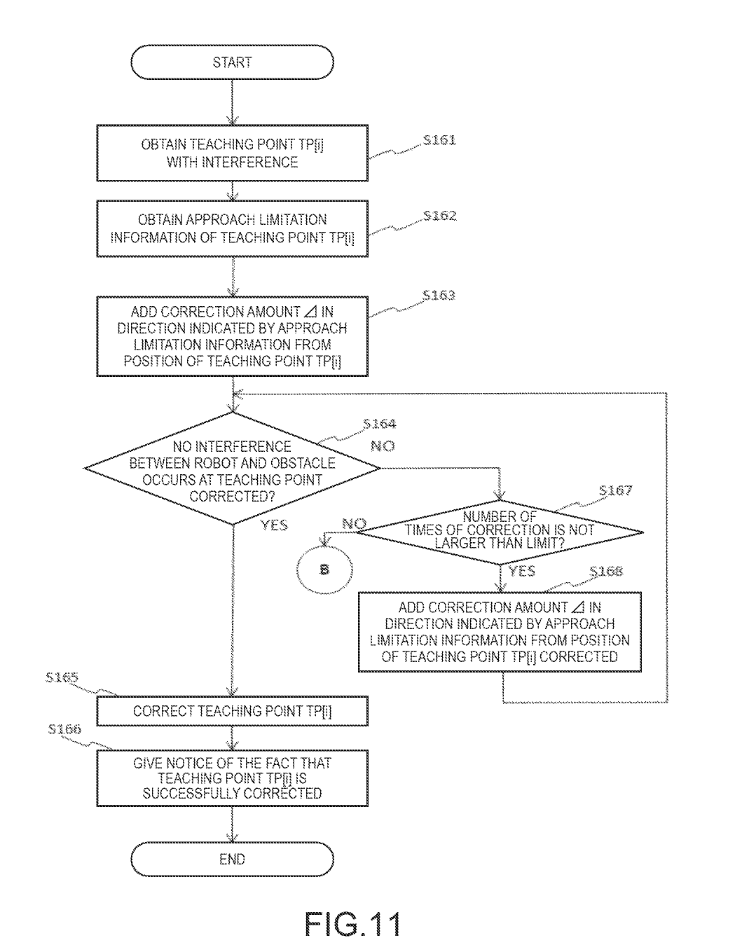

Going back to the explanation of FIG. 7, the teaching point parameter correction section 206 corrects the position of the teaching point at which the interference with the obstacle occurs based on the limitation information thus obtained. FIG. 11 is a flowchart showing the details of the present process.

The teaching point parameter correction section 206 obtains (step S161) the x coordinate, the y coordinate, and the z coordinate associated with the teaching point TP[i], which are the information related to the position of the teaching point TP[i] at which the interference with the obstacle occurs, namely the information stored in the tip position posture storage area 2101b, from the teaching point DB 210. The information obtained here is the same as the information obtained in the step S141.

The teaching point parameter correction section 206 obtains (step S162) the approach direction limitation information of the TP[i] from the approach limitation information storage area 2101e.

The teaching point parameter correction section 206 adds a correction amount Δ in the direction of the approach direction limitation information obtained in the step S162 from the position of the teaching point TP[i] to thereby correct (step S163) the position of the teaching point TP[i]. By using the approach direction limitation information, the correction direction of the teaching point is limited to the direction of departing from the obstacle surface.

It is possible to previously set a predetermined value to the correction amount Δ, or it is possible to arrange that the operator can change the correction amount Δ to an arbitrary value. In the case in which the correction amount Δ is large, there is a disadvantage that the amount of the movement of the movable section 15 for avoiding the obstacle becomes large, while there is an advantage that the processing time of the process for correcting the teaching point can be reduced. In contrast, in the case in which the correction amount Δ is small, since the amount of the movement of the movable section 15 for avoiding the obstacle becomes small, there is an advantage that the motion of the movable section 15 is similar to the original motion, and is therefore efficient, while there is a disadvantage that the processing time of the process for correcting the teaching point increases. Therefore, it is recommended to arrange that the teaching point parameter correction section 206 can change the correction amount Δ in accordance with the size of the robot 10 and the size of the work 40.

The teaching point parameter correction section 206 determines (step S164) whether or not the movable section 15 and the obstacle interfere with each other at the position of the teaching point TP[i] thus corrected in the step S163.

In the case in which the movable section 15 and the obstacle do not interfere each other at the position of the teaching point TP[i] thus corrected in the step S163 (YES in the step S164), the teaching point parameter correction section 206 stores (step S165) the position of the teaching point TP[i] thus corrected in the step S163 to the teaching point information 2101 as the position of the teaching point thus corrected. The information of the teaching point thus corrected in the teaching point information 2101 is different only in the x coordinate, the y coordinate, and the z coordinate of the tip position posture storage area 2101b from the information of the teaching point before the correction, and is the same in the rest as the information of the teaching point before the correction (an example thereof will be described later).

In the case in which the movable section 15 and the obstacle interfere with each other at the position of the teaching point TP[i] thus corrected in the step S163 (NO in the step S164), the teaching point parameter correction section 206 determines (step S167) whether or not the number of times of the correction is equal to or smaller than a predetermined number of times. It is possible to set the predetermined number of times in advance. It is also possible to arrange that the number of times of the correction can be changed in relation to the level of the correction amount Δ.

In the case in which the number of times of the correction is equal to or smaller than a predetermined number of times (YES in the step S167), the teaching point parameter correction section 206 adds the correction amount Δ in the direction of the approach direction limitation information obtained in the step S162 from the position of the teaching point corrected last to thereby correct (step S168) the position of the teaching point TP[i]. Subsequently, the teaching point parameter correction section 206 determines (step S164) whether or not the movable section 15 and the obstacle interfere with each other at the position of the teaching point TP[i] thus corrected in the step S168.

In the case in which the number of times of the correction is not equal to or smaller than the predetermined number of times (NO in the step S167), the teaching point parameter correction section 206 outputs the information representing the fact that the correction of the teaching point is unachievable to the central control section 201, and then the central control section 201 performs the process B (the error process).

### Step S18

Going back to the explanation of FIG. 7, the teaching point parameter correction section 206 outputs the information representing the termination of the teaching point correction (step S16) to the teaching point interference checking section 205. The teaching point interference checking section 205 determines whether or not the process shown in the steps S10 through S16 is completed with respect to all of the teaching points.

In the case in which the process shown in the steps S10 through S16 has not been completed with respect to all of the teaching points (NO in the step S18), the teaching point interference checking section 205 performs the process of the step S10 on the teaching point on which the process has not yet been performed.

In the case in which the process shown in the steps S10 through S16 has been completed with respect to all of the teaching points (YES in the step S18), the teaching point interference checking section 205 outputs the information representing the completion of the correction of the teaching points to the central control section 201, and then the central control section 201 performs a process A. The process A is the teaching point addition process (described later in detail).

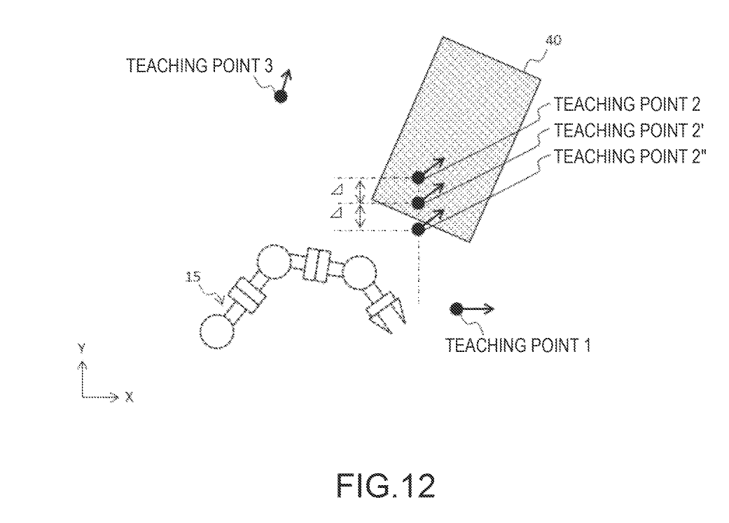

The teaching point correction process will be explained using FIG. 12. FIG. 12 is a diagram of the positional relationship identical to those shown in FIGS. 8 and 10. In FIG. 12, the teaching point 2 interferes with the work 40, and the approach direction limitation information is the directional unit vector DIR[1]. Therefore, the teaching point parameter correction section 206 determines the position shifted from the position of the teaching point 2 by the correction amount Δ in the direction of the directional unit vector DIR[1] as a corrected teaching point 2′. Since the interference with the work 40 occurs at the teaching point 2′, the teaching point parameter correction section 206 determines the position shifted from the position of the teaching point 2′ by the correction amount Δ in the direction of the directional unit vector DIR[1] as a corrected teaching point 2″. Since no interference with the work 40 occurs at the teaching point 2″, the teaching point parameter correction section 206 stores the position of the teaching point 2″ in the teaching point information 2101.

The information of the teaching point 2″ to be stored in the teaching point information 2101 will be explained. The teaching point number storage area 2101a stores 2″ representing the fact that the teaching point is the result obtained by performing the correction two times on the teaching point 2. Assuming that the position of the teaching point 2″ is (x2″, y2″, z2″), x2″ is stored in the x coordinate of the tip position posture storage area 2101b, y2″ is stored in the y coordinate thereof, and z2″ is stored in the z coordinate thereof. In the roll angle, the pitch angle, and the yaw angle of the tip position posture storage area 2101b, there are respectively stored R2, P2, and Y2, which are the same as the information of the teaching point 2. In the parameter storage area 2101c, the flag storage area 2101d, the approach limitation information storage area 2101e, and the departure limitation information storage area 2101f, there is stored the same information as that of the teaching point 2.

Thus, the teaching point correction process is terminated. Regarding the teaching point interfering with the obstacle, and not accompanied with the end effector operation process, it becomes possible to realize the operation of the robot 10 by changing the position of the teaching point. Further, by limiting the correction candidate of the teaching point to one direction, the processing time can be reduced. Further, by limiting the correction candidate of the teaching point to one direction, the amount of change of the position posture of the arm section 11 can be reduced.

### Process A

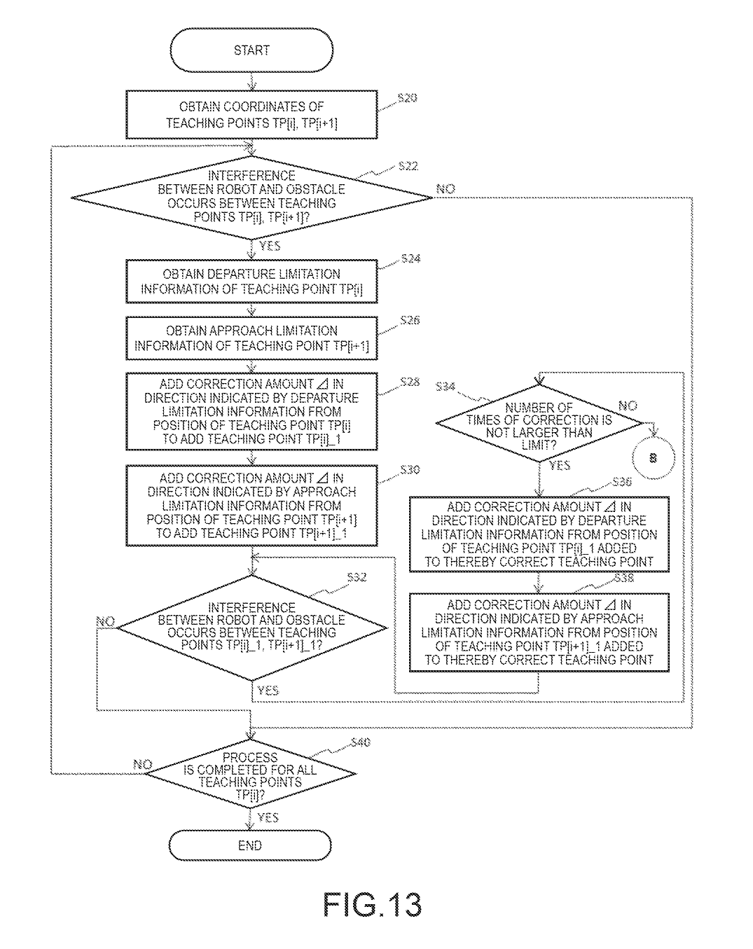

Then, the teaching point addition process (the process A) will be explained. FIG. 13 is a flowchart showing the flow of the teaching point addition process of the robotic system 1.

### Step S20

The teaching point interference checking section 205 obtains the position information (the x coordinate, the y coordinate, and the z coordinate) of the teaching point TP[i] and the next teaching point TP[i+1] from the teaching point information 2101 similarly to the case of the step S10. In the case in which the teaching point is corrected by the teaching point correction process, the teaching point interference checking section 205 obtains the position information of the teaching point thus corrected.

### Step S22

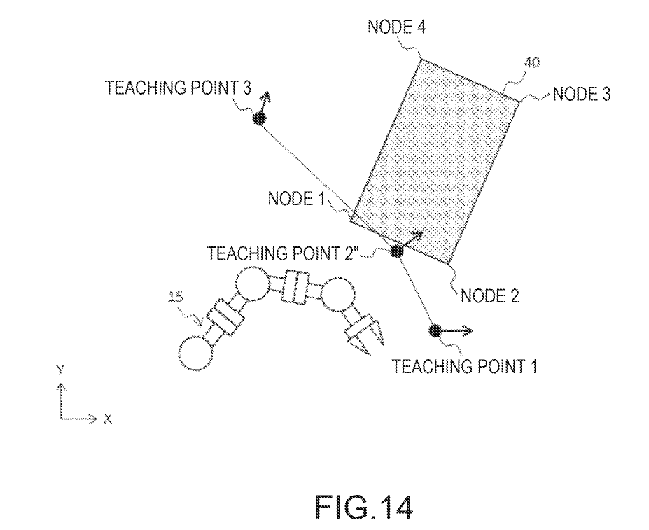

The teaching point interference checking section 205 obtains the obstacle information 2111 from the obstacle DB 211 similarly to the case of the step S10. Then, the teaching point interference checking section 205 determines whether or not the obstacle stored in the obstacle DB 211 and the robot 10 interfere with each other between a certain teaching point TP[i] and the next teaching point TP[i+1] stored in the teaching point information 2101. The present process will be explained specifically using FIG. 14. The position of the teaching point and the position of the obstacle shown in FIG. 14 are the same as those shown in FIG. 12.

The teaching point interference checking section 205 recognizes the area (the hatched section in FIG. 14) where the obstacle exists based on the obstacle information 2111 similarly to the case of the step S10.

The teaching point interference checking section 205 determines whether or not the line connecting the coordinates of the teaching points obtained from the tip position posture storage area 2101b overlaps the area where the obstacle exists. In FIG. 14, the line connecting the teaching point 2 and the teaching point 3 overlaps the area where the obstacle exists. Therefore, the teaching point interference checking section 205 determines that the interference with the obstacle occurs between the teaching point TP[i] and the teaching point TP[i+1] in the case of i=2.

In the case in which no interference with the obstacle occurs between the teaching point TP[i] and the teaching point TP[i+1] (NO in the step S22), the process proceeds to the step S40.

In the case in which the interference with the obstacle occurs between the teaching point TP[i] and the teaching point TP[i+1] (YES in the step S22), the process proceeds to the step S24.

### Step S24

The teaching point interference checking section 205 outputs the number (i.e., i) and the positional information of the teaching point TP[i] and the teaching point TP[i+1] to the teaching point parameter correction section 206. The teaching point parameter correction section 206 obtains the departure limitation information of the teaching point TP[i] from the departure limitation information storage area 2101f. In the case in which no information is stored in the departure limitation information storage area 2101f, the teaching point parameter correction section 206 generates the departure limitation information and then stores the departure limitation information in the departure limitation information storage area 2101f.

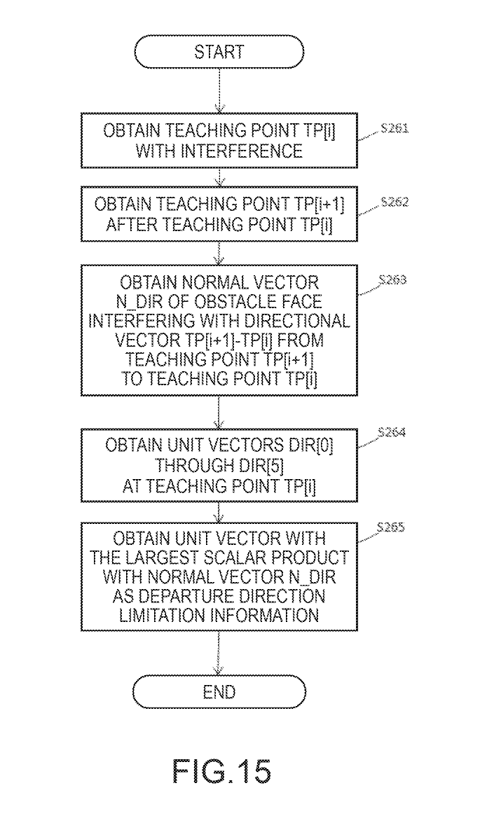

The method of generating the departure limitation information performed by the teaching point parameter correction section 206 will be explained. FIG. 15 is a flowchart showing the flow of a process of generating the departure limitation information performed by the teaching point parameter correction section 206.

The teaching point parameter correction section 206 obtains (step S261) the x coordinate, the y coordinate, and the z coordinate associated with the teaching point TP[i], which are the information related to the position of the teaching point TP[i] at which the interference with the obstacle occurs, namely the information stored in the tip position posture storage area 2101b, from the teaching point DB 210. The present process is identical to the process of the step S141.

The teaching point parameter correction section 206 obtains (step S262) the x coordinate, the y coordinate, and the z coordinate associated with the teaching point TP[i+1], which are the information related to the position of the teaching point TP[i+1] following the teaching point at which the interference with the obstacle occurs, namely the information stored in the tip position posture storage area 2101b, from the teaching point DB 210. In the case in which i=2 is set in the step S261, −TP[i+1]=3, namely the information related to the position of the teaching point 3 is obtained from the teaching point information 2101. The present process is different from the process of the step S142 only in the target teaching points, but is the same as the process of the step S142 in the process content.

The teaching point parameter correction section 206 obtains the directional vector TP[i+1]−TP[i] from the teaching point TP[i] to the teaching point TP[i+1] based on the positional information of the teaching points obtained in the steps S261, S262. Further, the teaching point parameter correction section 206 obtains the obstacle information 2111 from the obstacle DB 211, and then obtains (step S263) the normal vector N_DIR on the face of the obstacle interfering with the directional vector TP[i+1]−TP[i]. The present process is different from the process of the step S143 only in the target teaching points, but is the same as the process of the step S143 in the process content.

The teaching point parameter correction section 206 obtains (step S264) directional unit vectors DIR[0] through DIR[5] in the teaching point TP[i]. The present process is identical to the process of the step S144.

The teaching point parameter correction section 206 obtains (step S265) the directional unit vector having the greatest scalar product with the normal vector N_DIR out of the directional unit vectors DIR[0] through DIR[5] as departure direction limitation information. The present process is identical to the process of the step S145.

Thus, the departure direction limitation information is calculated. The teaching point parameter correction section 206 stores the departure direction limitation information thus calculated in the departure limitation information storage area 2101f of the teaching point information 2101, and then terminates the departure direction limitation information calculation process. It should be noted that the process shown in FIG. 15 is an example of the process of generating the departure limitation information, and the content of the departure limitation information is not particularly limited thereto.

### Step S26

Going back to the explanation of FIG. 13, the teaching point parameter correction section 206 obtains the approach limitation information of the teaching point TP[i+1] from the approach limitation information storage area 2101e. In the case in which no information is stored in the approach limitation information storage area 2101e, the teaching point parameter correction section 206 generates the approach limitation information and then stores the approach limitation information in the approach limitation information storage area 2101e. The present process is different from the process of the step S14 only in the target teaching point, but is the same as the process of the step S14 in the process content.

### Step S28

The teaching point parameter correction section 206 adds a new teaching point TP[i]_{—}1 based on the departure limitation information of the teaching point TP[i]. The teaching point TP[i]_{—}1 is added after the teaching point TP[i] (between the teaching point TP[i] and the teaching point TP[i+1]).

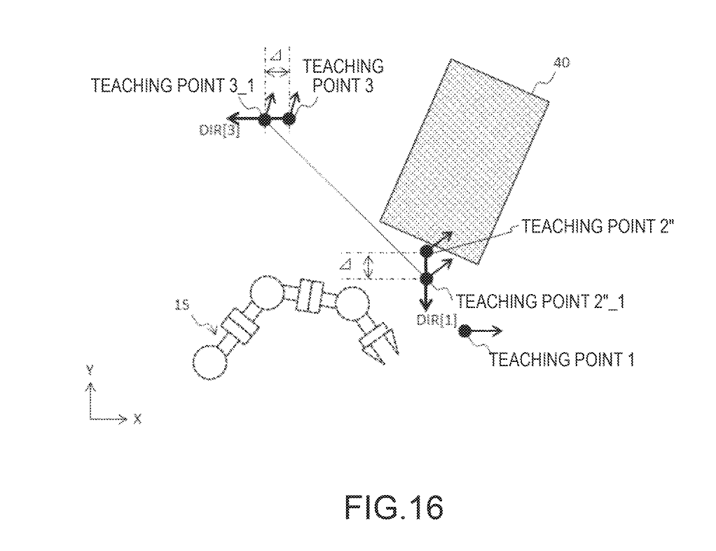

As shown in FIG. 16, assuming that the departure direction limitation information of the teaching point 2″ is the directional unit vector DIR[1], the teaching point parameter correction section 206 adds a teaching point 2″_{—}1 (the teaching point TP[i]_{—}1) at a position shifted from the position of the teaching point 2″ by the correction amount Δ in the direction of the directional unit vector DIR[1].

Further, the teaching point parameter correction section 206 stores the information of the teaching point TP[i]_{—}1 in the teaching point information 2101. The teaching point parameter correction section 206 outputs the information of the position of the teaching point TP[i]_{—}1 to the teaching point interference checking section 205.

The information of the teaching point TP[i]_{—}1 to be stored in the teaching point information 2101 will be explained. In the teaching point number storage area 2101a, there is stored the teaching point TP[i]_{—}1 representing the fact that the teaching point has been added. In the x coordinate, the y coordinate, and the z coordinate of the tip position posture storage area 2101b, there is stored the coordinate shifted from the position of the teaching point TP[i] by the correction amount Δ in the direction indicated by the departure limitation information. In the roll angle, the pitch angle, and the yaw angle of the tip position posture storage area 2101b, there is stored the same information as the information of −TP[i], respectively. In the parameter storage area 2101c, the flag storage area 2101d, the approach limitation information storage area 2101e, and the departure limitation information storage area 2101f, there is stored the same information as that of −TP[i].

### Step S30

The teaching point parameter correction section 206 adds a new teaching point TP[i+1]_{—}1 based on the approach limitation information of the teaching point TP[i+1]. The teaching point TP[i+1]_{—}1 is added before the teaching point TP[i+1] (between the teaching point TP[i]_{—}1 and the teaching point TP[i+1]). The teaching point parameter correction section 206 outputs the information of the position of the teaching point TP[i+1]_{—}1 to the teaching point interference checking section 205.

As shown in FIG. 16, assuming that the departure direction limitation information of the teaching point 3 is the directional unit vector DIR[3], the teaching point parameter correction section 206 adds a teaching point 3_{—}1 (the teaching point TP[i+1]_{—}1) at a position shifted from the position of the teaching point 3 by the correction amount Δ in the direction of the directional unit vector DIR[3].

Further, the teaching point parameter correction section 206 stores the information of the teaching point TP[i+1]_{—}1 in the teaching point information 2101 using substantially the same method as in the step S28.

### Step S32

The teaching point interference checking section 205 obtains the information of the positions of the teaching point TP[i]_{—}1 and the teaching point TP[i+1]_{—}1. The teaching point interference checking section 205 determines whether or not the obstacle and the robot 10 interfere with each other between the teaching point TP[i]_{—}1 and the next teaching point TP[i+1]_{—}1 (on the straight line connecting the teaching point TP[i]_{—}1 and the next teaching point TP[i+1]_{—}1) using substantially the same method as in the step S22.

In the case in which no interference between the obstacle and the robot 10 occurs between the teaching point TP[i]_{—}1 and the next teaching point TP[i+1]_{—}1 (NO in the step S32), the process proceeds to the step S40.

In the case in which the obstacle and the robot 10 interfere with each other between the teaching point TP[i]_{—}1 and the next teaching point TP[i+1]_{—}1 (YES in the step S32), the process proceeds to the step S34.

### Step S34

The teaching point interference checking section 205 outputs the fact that the teaching point TP[i]_{—}1 and the teaching point TP[i+1]_{—}1 should be corrected to the teaching point parameter correction section 206. The teaching point parameter correction section 206 determines (step S34) whether or not the number of times of the correction is equal to or smaller than the predetermined number of times. The present process is identical to the process of the step S167.

In the case in which the number of times of the correction is not equal to or smaller than the predetermined number of times (NO in the step S34), the teaching point parameter correction section 206 outputs the information representing the fact that the correction of the teaching point is unachievable to the central control section 201, and then the central control section 201 performs the process B (the error process).

In the case in which the number of times of the correction is equal to or smaller than the predetermined number of times (YES in the step S34), the process proceeds to the step S36.

### Step S36

Further, the teaching point parameter correction section 206 adds the correction amount Δ in the direction of the departure direction limitation information from the position of the teaching point TP[i]_{—}1 to thereby correct the position of the teaching point TP[i]_{—}1 using substantially the same method as in the step S28. The teaching point parameter correction section 206 rewrites the positional information of the teaching point TP[i]_{—}1 stored in the teaching point information 2101 to the position obtained in the step S36.

### Step S38

The teaching point parameter correction section 206 adds the correction amount Δ in the direction of the approach direction limitation information from the position of the teaching point TP[i+1]_{—}1 to thereby correct the position of the teaching point TP[i+1]_{—}1 using substantially the same method as in the step S30. The teaching point parameter correction section 206 rewrites the positional information of the teaching point TP[i+1]_{—}1 stored in the teaching point information 2101 to the position obtained in the step S36.

After the process of the step S38 is terminated, the teaching point parameter correction section 206 outputs the information of the positions of the teaching point TP[i]_{—}1 and the teaching point TP[i+1]_{—}1 to the teaching point interference checking section 205. Subsequently, the teaching point interference checking section 205 returns to the step S32.

### Step S40

The teaching point interference checking section 205 determines whether or not the process in the steps S20 through S38 has been performed with respect to all of the teaching points (all of the values of i).

In the case in which the process of the steps S20 through S38 has not yet been performed with respect to all of the teaching points (NO in the step S40), the teaching point interference checking section 205 returns to the process of the step S20.

In the case in which the process of the steps S20 through S38 has been performed with respect to all of the teaching points (YES in the step S40), the teaching point interference checking section 205 outputs the information representing the fact that the operation can be performed with the teaching points to the central control section 201, and then the central control section 201 terminates the process.

Thus, the teaching point addition process is terminated. In the case of adding a teaching point, by limiting the position of a new teaching point using the approach limitation information and the departure limitation information, the position of the new teaching point can be limited to the direction of departing from the surface of the obstacle. Further, by limiting the addition candidate position of the teaching point to one direction, a reliable and efficient teaching point addition process can be performed.

It should be noted that one of the features of the teaching point addition process is in particular to add the teaching point TP[i]_{—}1 after the teaching point TP[i], and add the teaching point TP[i+1]_{—}1 before the teaching point TP[i+1]. In the case of adding just one teaching point between the teaching point TP[i] and the teaching point TP[i]_{—}1, there are an infinite number of candidates of the position of the teaching point to be added, and it is not easy to determine the position of the teaching point to be added. In contrast, by limiting the teaching points, which are to be added, to the two teaching points, namely the teaching point corresponding to the teaching point TP[i] and the teaching point corresponding to the teaching point TP[i+1], the teaching point to be added can reliably be determined in a short period of time.

According to the present embodiment, the teaching point can automatically be corrected or added in the case in which the robot and the obstacle are going to collide with each other. Thus, a group of teaching points for realizing a desired operation can automatically be generated without any operation by the user.

For example, the teaching points 1, 2, and 3 are set originally as shown in FIG. 8, then the teaching point 2 is automatically changed to the teaching point 2″, and further the teaching points 2″_{—}1′, 3_{—}1 are automatically added for avoiding the obstacle. As a result, the movable section 15 can move sequentially to the teaching points 1, 2″_{—}1, 2″, 3_{—}1, and 3 without colliding with the obstacle.

Although the invention is hereinabove explained using the embodiment, the scope of the invention is not limited to the range of the description of the embodiment described above. It is obvious to those skilled in the art that a variety of modifications and improvements can be added to the embodiment described above. Further, it is obvious from the description of the appended claims that the configurations added with such modifications or improvements are also included in the scope of the invention.

The entire disclosure of Japanese Patent Application No. 2012-166728, filed Jul. 27, 2012 is expressly incorporated by reference herein.

What is claimed is:

1. A robotic system comprising:
an arm having a plurality of links and a plurality of joints;
an end effector disposed at a tip of the arm;
an operation control section adapted to move the arm so that the end effector moves along a plurality of teaching points;
a storage section adapted to store positional information of each of teaching points constituting the plurality of teaching points and limitation information in making the end effector approach the teaching point, each of which is information of each of the teaching points;
an acquisition section adapted to obtain positional information of an obstacle;
a first determination section adapted to determine whether or not one of the arm and the end effector and the obstacle interfere with each other at predetermined one of the plurality of teaching points when moving the end effector along the plurality of teaching points based on the positional information of the teaching point and the positional information of the obstacle; and
a changing section adapted to change a position of the predetermined one of the teaching points based on the limitation information in a case in which it is determined by the first determination section that one of the arm and the end effector and the obstacle interfere with each other at the predetermined one of the teaching points.

2. The robotic system according to claim 1, further comprising:
a second determination section adapted to determine whether or not the end effector performs an operation at the predetermined one of the teaching points,
wherein the changing section changes the position of the predetermined one of the teaching points in a case in which the end effector fails to perform the operation at the predetermined one of the teaching points.

3. The robotic system according to claim 1, wherein
the limitation information is information adapted to limit a direction in which the end effector is made to approach each of the teaching points, and
the changing section changes the position of the predetermined one of the teaching points by moving the predetermined one of the teaching points by a predetermined amount in a direction indicated by the limitation information.

4. The robotic system according to claim 1, further comprising:
a limitation information generation section adapted to generate the limitation information based on the position of the predetermined one of the teaching points, a position of another of the teaching points, through which the end effector passes before passing through the predetermined one of the teaching points, and a shape of the obstacle,
wherein the storage section stores the limitation information generated.

5. A robotic system comprising:
an arm having a plurality of links and a plurality of joints;
an end effector disposed at a tip of the arm;
an operation control section adapted to move the arm so that the end effector moves along a plurality of teaching points;
a storage section adapted to store positional information of each of teaching points constituting the plurality of teaching points, approach limitation information as limitation information in making the end effector approach the teaching point, and departure limitation information as limitation information in making the end effector depart from the teaching point, each of which is information of each of the teaching points;
an acquisition section adapted to obtain positional information of an obstacle;
a determination section adapted to determine whether or not one of the arm and the end effector and the obstacle interfere with each other between a first one of the plurality of teaching points and a second one of the plurality of teaching points through which the end effector passes subsequently to the first one of the plurality of teaching points when moving the end effector along the plurality of teaching points based on the positional information of the plurality of teaching points and the positional information of the obstacle; and
an addition section adapted to add a teaching point between the first one of the plurality of teaching points and the second one of the plurality of teaching points based on the approach limitation information and the departure limitation information in a case in which it is determined by the determination section that one of the arm and the end effector and the obstacle interfere with each other between the first one of the plurality of teaching points and the second one of the plurality of teaching points.

6. The robotic system according to claim 5, wherein
the addition section adds a third teaching point between the first one of the plurality of teaching points and the second one of the plurality of teaching points based on the departure limitation information with respect to the first one of the plurality of teaching points, and adds a fourth teaching point between the third teaching point and the second one of the plurality of teaching points based on the approach limitation information with respect to the second one of the plurality of teaching points.

7. The robotic system according to claim 6, wherein
the approach limitation information is information adapted to limit a direction in which the end effector is made to approach each of the teaching points,
the departure limitation information is information adapted to limit a direction in which the end effector is made to depart from each of the teaching points, and
the addition section determines a position obtained by shifting the first one of the plurality of teaching points by a predetermined amount in a direction indicated by the departure limitation information as a position of the third teaching point, and adds the fourth teaching point at a position obtained by shifting the second one of the plurality of teaching points by a predetermined amount in a direction indicated by the approach limitation information.

8. The robotic system according to claim 5, further comprising:
a limitation information generation section adapted to generate the approach limitation information and the departure limitation information based on the positions of the first one of the plurality of teaching points and the second one of the plurality of teaching points and a shape of the obstacle,
wherein the storage section stores the approach limitation information generated and the departure limitation information generated.

9. A robot control device comprising:
an operation control section adapted to move an arm having a plurality of links and a plurality of joints so that an end effector disposed at a tip of the arm moves along a plurality of teaching points;
an acquisition section adapted to obtain positional information of each of teaching points constituting the plurality of teaching points, approach limitation information as limitation information in making the end effector approach the teaching point, and departure limitation information as limitation information in making the end effector depart from the teaching point, each of which is information of each of the teaching points, and positional information of an obstacle;
a determination section adapted to determine whether or not one of the arm and the end effector and the obstacle interfere with each other between a first one of the plurality of teaching points and a second one of the plurality of teaching points through which the end effector passes subsequently to the first one of the plurality of teaching points when moving the end effector along the plurality of teaching points based on the positional information of the plurality of teaching points and the positional information of the obstacle; and
an addition section adapted to add a teaching point between the first one of the plurality of teaching points and the second one of the plurality of teaching points based on the approach limitation information and the departure limitation information in a case in which it is determined by the determination section that one of the arm and the end effector and the obstacle interfere with each other between the first one of the plurality of teaching points and the second one of the plurality of teaching points.
